(19) United States
(12) Patent Application Publication
(10) Pub. No.: US 2005/0286246 A1
(43) Pub. Date: Dec. 29, 2005

(54) Veneer integrated flat conductor cable, lighting device and connectors

(76) Inventors: Jerold Thomas Coon, Fife Lake, MI (US); Bradley William Lockhart, South Boardman, MI (US)

Correspondence Address: Jerold T. Coon, 12590 Coster Road, Fife Lake, MI, 49633, US

(21) Appl. No.: 11/156,005

(22) Filed: Jun. 20, 2005

Related U.S. Application Data
(60) Provisional application No. 60/582,157, filed on Jun. 24, 2004.

(51) Int. Cl. F21V 1/00

(52) U.S. Cl. 362/235

(57) ABSTRACT

A decorative veneer integrated with flat conductive ribbon cable. The apparatus is designed to allow easy installation of decorative wiring in a multitude of situations. The apparatus is also designed to be integrated with light emitting diodes to provide a decorative veneer lighting fixture with a multitude of uses.

We claim the benefit of Provisional Patent 60/582,157 and it is incorporated herein in its entirety by reference.

### BACKGROUND

1. Field of the Invention

This invention relates generally to the field or device for a decorative veneer integrated with flat conductor cable for a multitude of low voltage purposes.

Moreover it pertains specifically to such device and method for combining the decorative aspects of veneer integrated with flat conductor cable which may be adhered directly to a wall, molding, ceiling, or other surface providing flexible decorative self adhesive wiring for telephone or audio systems in residences or other buildings.

Combined with light emitting diodes the device and method also provides a flexible decorative lighting fixture, which may be adhered directly to a wall, ceiling, molding, cabinet or other surface providing decorative self-adhesive low voltage lighting.

2. Description of Related Art

Flat conductor cable has been commercially available for many years and numerous patents have been filed for various forms of connectors. Rizzio, Jr. et al. U.S. Pat. No. 3,989,336; Dijkshoom U.S. Pat. No. 5,133,673; Roder et al. U.S. Pat. No. 5,860,831; Sai U.S. Pat. No. 6,068,505; Morris et al. U.S. Pat. No. 6,109,928; Bulmer et al. U.S. Pat. No. 6,394,833; Hayes et al. U.S. Pat. No. 6,604,966; and Kreutzer U.S. Pat. No. 6,641,427 are all demonstrative. Although flat conductor cable is designed to be flat, the prior art for connectors discloses no connectors that are in fact flat, as compared to the cable they are connecting. Dijkshoom and Sai reveal mechanical devices that provide a lower profile than the other prior art, but neither can be easily concealed by painting or covering with veneer.

Many devices in the prior art have been proposed to combine lights within flat elongated strips. Miniature lights mounted on tape are shown in Chao U.S. Pat. No. 3,894,225. Chao et al. U.S. Pat. No. 3,995,152 reveals a low voltage light strip encased in clear plastic. Hoyt reveals low voltage lights mounted on printed circuit board with mechanical connectors, and Hayes reveals light emitting diodes fastened to flat conductor cable by a piercing and clamping method. However, none have decorative aspects other than the lights themselves and none provide practical means for concealing the strips to which the lights are attached.

Flat conductor cable is not designed specifically for telecom or audio wiring but can be produced by numerous manufacturers with conductors suitable for the purpose. A modified flat conductive wiring for audio and telecom is shown in Sexton, U.S. Pat. No. 6,492,595 and is commercially available through Decorp. Although the Decorp flat surface mounted wires can be painted or hidden under plaster, the method of concealment would require defacing the existing wall, ceiling, or other surface. Also, the connectors for the Decorp products are neither flat nor concealable in the same manner as the wires.

None of the prior art provides flat decorative wiring with flat connectors which can be concealed without marring, defacing or painting the existing sub-surface. Likewise, none of the prior art could be used and hidden along or on top of existing molding such as base board or cove moldings commonly found in residential homes.

The present invention overcomes these deficiencies in the prior art by exposing the conductors of the flat conductor cable on one side, which allows a three-step application process. First the flat conductor cable, with the conductors (with or without light emitting diodes) is applied to the wall, ceiling, molding, cabinet or other sub-surface. Second the device is connected to the power source. Because the conductors are exposed, any splices or connections can also be made at this time. Then the matching decorative veneer is applied over the flat conductor cable to complete the insulation of the conductors and form one complete unit. Prior to the final step the veneer can be painted, stained or varnished to match the existing sub-surface without marring the sub-surface or covering the light emitting diodes.

The flat connectors allow the user to cut and splice the flat conductor cable to any length. The flat connectors also allow the user to apply the device around doors or other vertical obstructions on a wall during installation. All of which can be hidden under the decorative veneer.

It is therefore an object of the present invention to provide a new and improved more universal decorative device and method which consists of a decorative self-adhesive veneer integrated with flat conductor cable for use as a decorative apparatus for telephone wire, audio speaker wire, or other similar low voltage wiring and as a low voltage lighting fixture which addresses the deficiencies of the prior art.

### OBJECTS OF THE INVENTION

A principal object of the present invention is to provide a decorative veneer wiring device that will overcome the deficiencies of the prior art devices.

Another object of the present invention is to provide a decorative veneer wiring device with two or more flat conductors whose specifications, (gauge and conductivity) can be matched for uses for telephone wiring, audio wiring or lighting.

Another object of the present invention is to provide a decorative veneer wiring device integrated with light emitting diodes that can be used as a decorative light fixture.

Another object of the present invention is to provide a decorative veneer wiring device that is easily installed with little or no modification to existing wiring or construction.

Another object of the present invention is to provide a decorative veneer wiring device that can be painted, stained or varnished to match existing walls or trim, without marring, defacing or painting the existing walls or trim.

Another object of the present invention is to provide a decorative veneer wiring device that is flexible and can be installed continuously around corners.

Another object of the present invention is to provide a decorative veneer wiring device with straight or angled connectors for installation around doorways or other vertical obstructions.

Another object of the present invention is to provide a decorative veneer wiring device that can be cut to any length necessary to effectuate installation.

It is intended that any other advantages and objects of the present invention that become apparent or obvious from the detailed description or illustrations contained herein are within the scope of the present invention.

### SUMMARY OF THE INVENTION

In view of the limitations now present in the prior art, the present invention provides a new and useful device and method which integrates decorative veneer with flat conductor cable which is more universally usable and more versatile in operation than any known apparatus.

The purpose of the present invention is to provide a new decorative veneer device integrated with flat conductor cable that has many novel features not offered by the prior art that results in a new decorative wiring method and light fixture device which is not apparent, obvious, or suggested, either directly or indirectly by any of the prior art.

One aspect of the present invention comprises of wood, plastic or other non-metallic veneer strips adhered with pressure sensitive adhesive to flat conductor cable for use as decorative telephone wire or audio speaker wire. The veneer component is standard edging common to the veneer industry.

The flat conductor cable is common to the electronics industry for connecting various electronic components whereby two or more flat metallic conductors are adhered to and encased in flat polyester ribbon or other similar flexible material. In the present invention, manufacture of the flat conductor cable would be similar to the current common methods, except the polyester ribbon is placed only on one side thus leaving the conductors exposed on one side of the cable.

The decorative veneer is adhered to the exposed side of the flat conductor cable with pressure sensitive non-conductive adhesive. Double-sided pressure sensitive tape is applied to the reverse side of the flat conductor cable to allow the entire device to be adhered to a wall, ceiling, molding, cabinet or other surface. Angled connectors allow continuous wiring around doorways or other obstructions.

Another aspect of the present invention generally is comprised of wood, plastic, or other non-metallic veneer strips adhered with pressure sensitive non-conductive adhesive to flat conductor cable. Said decorative veneer, having holes at regular intervals to accept surface mounted light emitting diodes, which may be soldered to the flat conductor cable.

The foregoing has outlined, in general, the physical aspects of the invention and is to serve as an aid to better understanding the more complete detailed description, which is to follow. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### BRIEF DESCRIPTION OF THE DRAWINGS

The following drawings further describe by illustration the advantages and objects of the present invention. Each drawing is referenced by corresponding figure reference characters within the “DETAILED DESCRIPTION OF THE INVENTION” section to follow.

FIG. 1. is a perspective view of a decorative veneer wiring device according to the present invention with the flat conductor cable (1) and conductors (5) adhered to wood veneer (2) by means of pressure sensitive non-conductive adhesive tape (3).

FIG. 2. is a perspective view of a decorative veneer wiring device according to the present invention with the flat conductor cable (1) and conductors (5) adhered to wood veneer (2) by means of pressure sensitive non-conductive adhesive tape (3). Also showing holes in the veneer (4) to accept the light emitting diodes (6) soldered to the conductors (5).

FIG. 3. is a rear view of a straight connector (7) with pressure sensitive non-conductive adhesive tape (3) and conductive pressure sensitive adhesive tape (9) overlaying the conductors according to the present invention.

FIG. 4. is a rear view of a 90 degree connector (8) with pressure sensitive non-conductive adhesive tape (3) and conductive pressure sensitive adhesive tape (9) overlaying the conductors according to the present invention.

FIG. 5. depicts the placement of flat conductor cable when making 90 degree corner according to the present invention.

FIG. 6. depicts the placement of the 90 degree connector over the flat conductor cable when making 90 degree corner according to the present invention.

FIG. 7. depicts the placement of the decorative veneer when making 90 degree corner according to the present invention.

FIG. 8. depicts the placement of flat conductor cable on base board molding around a corner according to the present invention.

FIG. 9. depicts the placement of veneer stained to match the base board molding and covering the flat conductor cable according to the present invention.

### DETAILED DESCRIPTION OF THE INVENTION

The invention generally consists of a decorative self-adhesive veneer integrated with flat conductor cable for use as a decorative apparatus for telephone wire, audio speaker wire, or other similar low voltage wiring and as a low voltage lighting fixture.

Referring now descriptively to the drawings:

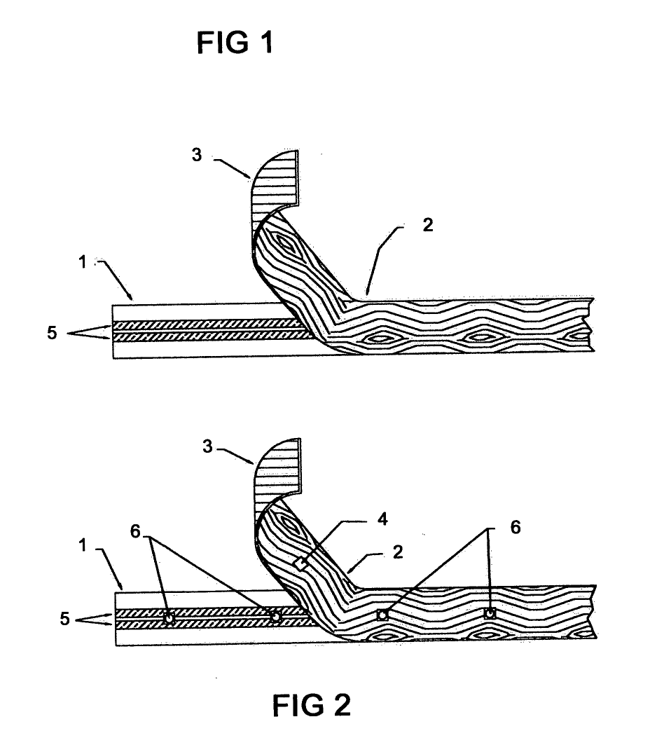

The present invention consists of a decorative veneer strip (2), pressure sensitive non-conductive adhesive (3), two or more flat conductors (5) and flat conductor cable (1) that are part of a single embodiment as seen in FIG. 1.

The decorative veneer strip (2) may be of wood, plastic or other non-metallic material. Numerous species of wood veneer strip are commercially available in unfinished or pre-finished state. The decorative veneer may be any width necessary for the apparatus, but commonly will be 0.125 to 1 inch. The thickness of the veneer strip (2) can be 8 mils to 125 mils depending on the material and intended use.

The pressure sensitive non-conductive adhesive tape is commercially available (3) and will be manufactured to the same width as the decorative veneer (2) and flat conductor cable (1). The adhesive preferably would be applied in double sided tape form, first being applied to the decorative veneer (2) during manufacture and then being applied to the flat conductor cable (1) during installation.

The flat conductor cable is also commercially available. It commonly consists of two or more flat metallic conductors of copper or copper-tin alloy encased in a polyester ribbon. The flat conductor cable (1) will be manufactured to the same width as the decorative veneer (2). The flat conductor cable (1) will also have pressure sensitive adhesive (3), first being applied to the back of the flat conductor cable during manufacture and then being applied to the wall, cabinet, molding or other surface during installation. The flat conductor cable (1) will also be manufactured with the conductors (5) exposed on one side to allow for connections to be made with the connectors (7)(8).

The connectors (7)(8) will be manufactured to match the width of the decorative veneer.

FIG. 2 shows another embodiment. The decorative veneer (2) is manufactured with holes (4) sized and spaced to fit surface mounted light emitting diodes (6). The decorative veneer (2) could also be manufactured to a thickness which would allow the light emitting diodes to be flush with the outside surface of the veneer after installation, thus offering protection to the diodes.

The light emitting diodes (6) would be low profile and surface mounted to the conductors (5) on the flat conductor cable (1). The light emitting diodes (6) would be soldered to the flat conductor cable (1) during manufacture. The connectors would be of the size, spacing and thickness necessary for the requirements of the light emitting diodes. The device could be manufactured in continuous rolls with the diodes equally spaced along the device.

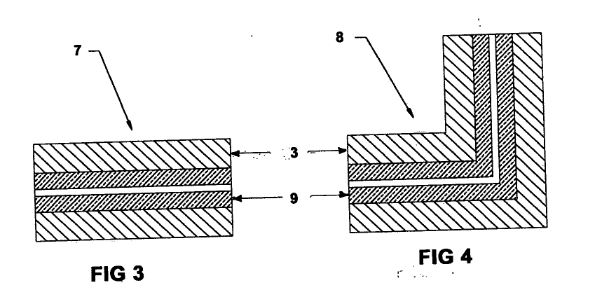

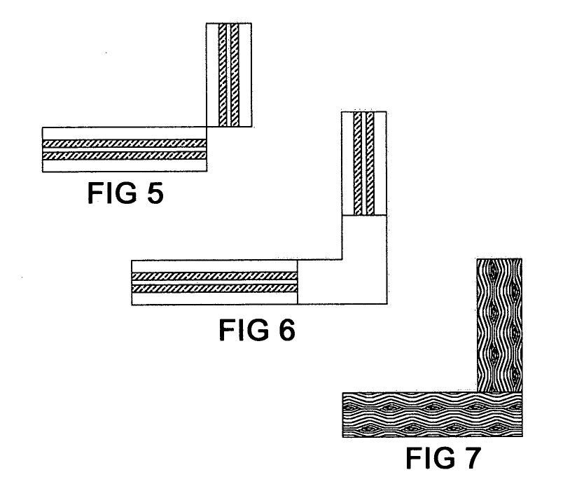

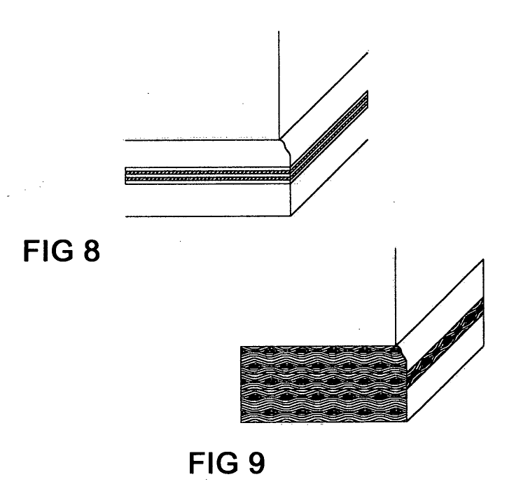

As seen in FIGS. 3 AND 4 The connectors preferably are made of flat conductor cable and will have pressure sensitive non-conductive adhesive (3) applied to the outside edges to promote bonding with the flat conductor cable (1), as well as with pressure sensitive conductive adhesive (9) on the conductors (5) to promote continuous connection along the circuit. Both the non-conductive and conductive adhesives would be in double sided tape form, first being applied to the connector (7)(8) during manufacture, then to the flat conductor cable (1) during installation.

All adhesives are covered with removable tape backing until installation.

All embodiments allow for the decorative veneer (2) to be painted, stained or varnished to match existing trim or wall coverings prior to installation.

Preferably the device would be installed in three steps. First the flat conductor cable would be installed by peeling off the removable tape backing and sticking the flat conductor cable to the wall or other surface. Alternatively the flat conductor cable could be applied to the wall or other surface using commercially available glue or bonding agent. The flat conductor cable could be cut to any length and spliced using a connector, thus allowing the flat conductor cable to be routed around doors or other obstructions. Second, the flat conductor cable would be connected to the power source and checked for continuity. Third the decorative veneer would be installed by peeling off the removable tape backing and sticking the decorative veneer directly over the flat conductor cable and connectors. Prior to the application of the decorative veneer, the decorative veneer would be stained, varnished or painted to match the existing wall or other surface. Application of the decorative veneer thus completes the insulation of the conductors as well as provides the decorative aspects of the invention.

Therefore the invention provides a new decorative veneer integrated with flat conductor cable method and device that has many novel features not offered by the prior art that results in a new decorative wiring method and light fixture device which is not apparent, obvious, or suggested, either directly or indirectly by any of the prior art.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

1. A decorative device for low voltage wiring, the device comprising:
flat conductor cable being about 0.75 inches in width, with two or more conductors exposed on one side of the cable;
veneer, selected from the group consisting of, wood, plastic or other non metallic substance and being the same width as the flat conductor cable;
double sided adhesive tape adhered to the flat conductor cable; and
double sided non-conductive adhesive tape adhered to the veneer.
a means for connecting the device to a low voltage power source.

2. A method of installing the device of claim 1 wherein:
the flat conductor cable is adhered to a wall, ceiling, or other surface, using said double-sided adhesive;
the flat conductor cable is connected to the low voltage power source;
the veneer is stained, varnished or painted to match an existing wall, ceiling or other sub-surface; and then
the veneer is adhered to the flat conductor cable using the double sided non-conductive adhesive tape.

3. A decorative device for low voltage lighting, the device comprising:
flat conductor cable being about 0.75 inches in width, with two conductors exposed on one side of the cable;
light emitting diodes a fixed to the conductors at equal intervals along the flat conductor cable;
veneer, selected from the group consisting of, wood, plastic or other non metallic substance; said veneer having holes matching the size and shape of said light emitting diodes spaced at the same intervals as the light emitting diodes on the flat conductor cable and being the same width as the flat conductor cable;
double sided adhesive tape adhered to the flat conductor cable; and
double sided non-conductive adhesive tape adhered to the veneer.

4. A method of installing the device of claim 3 wherein:
the flat conductor cable is adhered to a wall, ceiling, molding, cabinet or other surface, using said double-sided adhesive;
the flat conductor cable is connected to the low voltage power source;
the veneer is stained, varnished or painted to match an existing wall, ceiling or other sub-surface; and then
the veneer is adhered to the flat conductor cable using the double sided non-conductive adhesive tape.

5. A low voltage connector, said devise comprising:
a flat conductor cable about 1.5 inches in length and the same width as the flat conductor cable in claims 1 and 3;
the connector having conductors the same width and spacing as the conductors of the flat conductor cable in claims 1 and 3; and
double sided non-conductive adhesive tape adhered to the outside edges of the connector; and
double sided conductive adhesive tape adhered to the conductors.

6. The devise in claim 5, wherein the connector forms an angle, each leg of the angle being about 0.75 inches in length and the same width as the flat conductor cable in claims 1 and 3.
the connector having conductors the same width and spacing as the conductors of the flat conductor cable in claims 1 and 3; and
double sided non-conductive adhesive tape adhered to the outside edges of the connector; and
double sided conductive adhesive tape adhered to the conductors.

7. A method of installing the device of claim 1 and 3 wherein:
the flat conductor cable is adhered to a wall, ceiling, molding, cabinet or other surface, using said double-sided adhesive;
the flat conductor cable is spliced or routed around obstructions by adhering the low voltage connector to the flat conductor cable;
the flat conductor cable is connected to the low voltage power source;
the veneer is stained, varnished or painted to match an existing wall, ceiling or other sub-surface; and then
the veneer is adhered to the flat conductor cable and connector using the double sided non-conductive adhesive tape.
